(19) United States
(12) Patent Application Publication
(10) Pub. No.: US 2018/0240363 A1
(43) Pub. Date: Aug. 23, 2018

(54) LAPTOP COMPUTER WITH USER INTERFACE FOR BLIND, AND METHOD FOR USING THE SAME

(71) Applicant: Nitin Vats, Meerut (IN)

(72) Inventor: Nitin Vats, Meerut (IN)

(73) Assignee: Nitin Vats, Meerut (IN)

(21) Appl. No.: 15/752,595

(22) PCT Filed: Aug. 14, 2015
(86) PCT No.: PCT/IN2015/000324

§ 371 Date: Feb. 14, 2018

(51) Int. Cl. G09B 21/00; G06F 3/01; G06F 3/0489

(52) U.S. Cl. CPC G09B 21/004; G09B 21/005; G06F 3/0489; G06F 3/016

(57) ABSTRACT

A computing device for visually impaired with a tactile refreshable Braille display, the display is adapted to show a computer application, the computer application is characterized by presence of one of command/control/tool button symbols and names and/or a reading material having at least one of headings names, hyperlink name, or compressed data name and detailed text or graphical GUI, the display is adapted to show the computer application by a combination of one or more of the following:
a unique Braille symbol at different placing on tactile surface represents different command/control button symbols and names, headings names, hyperlink name or compressed data name, wherein meaning of the unique Braille symbol depends according to its placing on the tactile display.
standard Braille character/s representing the detailed text, and
standard Braille character/s at a first predefined region in the tactile display to show meaning of the unique Braille symbol according to placing on tactile surface.

### FIELD OF INVENTION

The present invention generally relates to the field of computing device like laptop and desktops with user interface for blind people, and a method for using the same. More particularly, the invention relates to showing user interface of pages/application on tactile display similar to GUI designed for normal computers irrespective of size difference between computer screen pixel and Braille pixel.

### BACKGROUND OF THE INVENTION

There is a wide gap in the existing technology and systems related to human-machine interaction, particularly interaction with computers available for visually impaired, completely blind people, or both deaf and blind people or people who are blind, deaf and also mute as compared to user interfaces available and used by people with normal vision. Braille is the most common tactile presentation method used by visually impaired people. Each Braille character consists of either a three row by two column “6-dot Braille cell”, or a four row by two column “8-dot Braille cell” with combinations of raised dots allowing individual patterns. The patterns represent the letters of the alphabet, numbers and punctuation, capitals letters, italicized letter and symbols.

Currently the interaction of blind people with computers is either by the use of on-screen readers which read out words line by line displayed on screen, 8 keys Braille input and/or combination of 8 keys Braille input and QWERTY keyboard, or separate Braille keyboards or tactile input forms that are complicated to use. Unfortunately, the assistive on-screen readers which reads out words cannot be used by people who are both deaf and blind, and further such systems attract unnecessary attention towards blind people, and cannot be used in public library or places where silence is expected.

In refreshable Braille display, the input is performed by two sets of three keys and a space bar, whereas output is through a refreshable Braille display consisting of one or more rows of electromechanical character cells. In one implementation, such as U.S. Pat. No. 6,354,839 B1, discloses a refreshable Braille display using micro-electromechanical actuators for helping blind person to discern information displayed on the display. Another U.S. Pat. No. 6,712,613 B2 discloses a display device which displays image information in a tactile output for blind. Another U.S. Pat. No. 8,085,253 B2 discloses a computer for blind. However, such display, laptop, and other existing user interfaces, methods and technology provide limited functionality, and usage of these systems is complicated, and not self-exploratory for blind people, especially due to their input and output Interface. It is convenient to receive input and generate output dynamically in tactile form which is not only perceivable but also easily comprehensible by blind users on the same display or user interface similar to available electronic touch screens displaying a Graphical User Interface. Further, in existing user interfaces and/or computer for blind, information in presented in full text form, where blind user has to go through entire text line by line to understand/comprehend the content, and it is difficult to skip reading unnecessary content.

Therefore, there is a long felt need to provide an ideal laptop computer and/or a user interface that is self-exploratory, and that makes human-machine interaction or human-computer interaction simplified for visually impaired, blind, both deaf and blind, and also for deaf and blind and mute people in a way such that blind people are able to easily provide input and comprehend output. There is a need that blind people are able to interact and operate computing devices such as laptop, computers and the like independently similar to a person with normal vision operating a conventional PC/laptop using a Graphical User Interface. There is a demanding need to enable blind to fully use/operate a computer—from writing word-like documents, to being able to draw, to navigating the Internet independently.

The object of the invention is to provide a visually impaired friendly computing device and user interface for it.

### SUMMARY OF THE INVENTION

The object of the invention is achieved by computing device of the claim 1.

The computing device for visually impaired has a tactile refreshable Braille display, the display shows a computer application, and the computer application is characterized by presence of one of command/control/tool button symbols and names and/or a reading material having at least one of headings names, hyperlink name, or compressed data name and detailed text or graphical GUI. The display is adapted to show the computer application by a combination of one or more of the following:

a unique Braille symbol at different placing on tactile surface represents different command/control button symbols and names, headings names, hyperlink name or compressed data name, wherein meaning of the unique Braille symbol depends according to its placing on the tactile display.

standard Braille character/s representing the detailed text, and

standard Braille character/s at a first predefined region in the tactile display to show meaning of the unique Braille symbol according to placing on tactile surface.

According to one aspect of the computing device, the computing device includes one or more input device from a selection of a tactile keyboard, a touch sensitive tactile display, stylus for refreshable tactile surface and voice recognition based input device.

According to another embodiment of the computing device, wherein the tactile display is adapted to show operating system related command buttons as Operating system based Braille symbol which are adapted to be executed by a first type of user input and to be operated to show meaning of the buttons in the first predefined region on receiving second type of input on the command buttons.

According to yet another embodiment of the computing device, wherein the tactile is adapted to display a fill-in box as a unique Braille symbol and on application of user input over the input box, the display is adapted to open the fill-in box in a second predefined region.

According to one aspect of the computing device, a piece of code stored in a memory device which on execution over a processor is adapted to perform the following steps of:

converting data fetched to be displayed on the display device, such that the display device is adapted to display the data according to any of the claims 1 to 4.

According to another embodiment of the computing′ device, wherein the display is made of refreshable tactile surface where Braille pixels appear on the surface through the movement of pins, where movement is generated through the electricity based actuators.

According to yet another embodiment of the computing device, the computing device includes a Braille typing interface to type onto the display in Braille.

According to one aspect of the computing device, the computing device includes a drawing interface to physically interact with the tactile surface to draw onto the tactile surface of the display.

According to another embodiment of the computing device, the computing device includes a voice output utility which is adapted to convert the desired output shown on display into audio.

### BRIEF DESCRIPTION OF THE DRAWINGS

The invention and many advantages of the present invention will be apparent to those skilled in the art by going through the accompanying drawings and a reading of this description taken in conjunction with drawings, in which like reference numerals identify like elements.

FIG. 1 illustrates a laptop computer in an open position with a user interface according to an embodiment of the present invention.

FIG. 2A-19A, 21A shows conventional (prior art) laptop computer with Graphical User Interface depicting different operations.

FIG. 2B-9B illustrates using or operating the laptop computer and/or the user interface of FIG. 1 for writing notes and verifying written notes in one example.

FIG. 10B-16B illustrates using or operating the laptop computer and/or the user interface of FIG. 1 for navigating the Internet independently in one example.

FIGS. 17B, 18B, 19B, 20 and 21B illustrates using or operating the laptop computer and/or the user interface of FIG. 1 for creating drawings in one example.

### DETAILED DESCRIPTION

One or more described implementations provide a laptop computer with user interface for blind people. The laptop computer and/or the user interface may be used by visually impaired, completely blind, or by people who are both blind and deaf, or people who are blind, deaf and also mute. The user interface comprises a single interface for generating tactile output for enabling a blind user to read data, and for receiving tactile input from user. The interface comprises of four types of regions. The first type of region is adapted as first tactile symbol representing computer icon or referring to compressed data, where to read the first tactile symbol, a tactile input is provided on the first tactile symbol which provides details or explanation for the first tactile symbol in a fourth region. The second type of region adapted as second tactile symbols is provided in the interface for selecting instruction directly that the second tactile symbols represents. A third type of region is adapted to output text data in tactile Braille characters form and/or free form tactile output for representing drawings or arbitrary tactile shapes or lines other than Braille Characters. The third region is also adapted to receive tactile input directly on the interface or receive input via one or more input device. The fourth type of region is adapted to output text data in tactile Braille characters either as a tactile response to input on the first tactile symbol for providing details or explanation or as a tactile response to input received from one or more input device.

The present invention also provides solution and a smart way to read and comprehend data or different sections of content quickly by reading headings presented in tactile form as a single tactile symbol, where the single tactile symbol represents computer icon as in Graphical User Interface or refers to compressed data having further details.

The invention has advantages that:

(a) Blind people can not only type using one or more input devices such as keyboard or tactile input, but also verify what is written by dynamically generated tactile output easily on the user Interface of the present invention.
(b) Dynamic user interface offer greater flexibility and independence.
(c) The user interface of present invention is designed such that the computer can be operated not only by visually impaired or completely blind people, but also by people who are both deaf and blind, and/or by people are deaf, blind, and also mute.
(d) The silent mode of operation makes it possible for blind or visually impaired people to use the laptop in public library or places where silence is expected, without attracting any unnecessary attention towards blind people.
(e) The laptop computer and/or user interface of the present invention is simplified in terms of proving input and comprehending output making navigation easy such as identification and understanding of icons, folder structure very quickly just like a person operating a conventional PC/laptop with normal vision using a Graphical User Interface, taking notes using a note pad or word processor for typing and simultaneous verification of what is being typed independently, without requiring any assistance, and with limited training.
(f) Cost-effective even with more functionalities.
(g) The user interface provides a new and easy way of navigating computer, and is self-sufficient and no special accessories required to operate.
(h) The user interface can be used with existing operating systems such as Android, Linux, Microsoft Windows, which converts the standard output of text and graphics to dynamically generate tactile Braille output or specially customized operating systems.
(i) The layout of user interface for blind and people with normal vision is very similar, making discussions over the output generated over the user interface and/or laptop computer of the present invention very simplified and easily comprehensible. The use of tactile symbol to represent compressed data makes easy to comprehend dynamically generated tactile output, and maintains the layout of data even if less tactile elements are used to represent particular layout in blind computer and/or user interface which otherwise requires more pixels to represent such particular data in conventional computer used by people with normal vision.

One or more described implementations provides a laptop computer with user interface for blind people, and a method for using the same. The laptop computer with the user interface of the present invention may be operated by visually impaired and blind. The laptop computer and/or the user interface of the present invention can also be used by people who are both blind and deaf, and people who are blind, deaf and also mute.

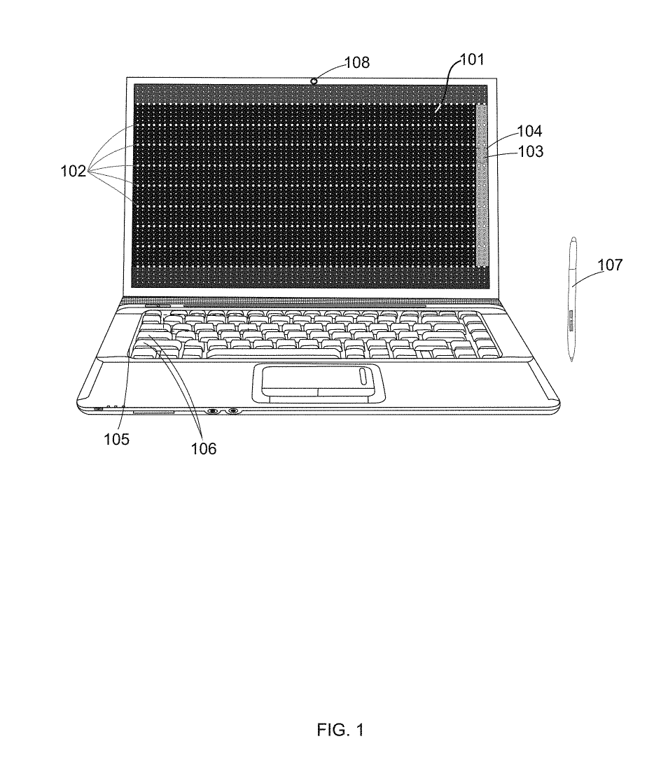

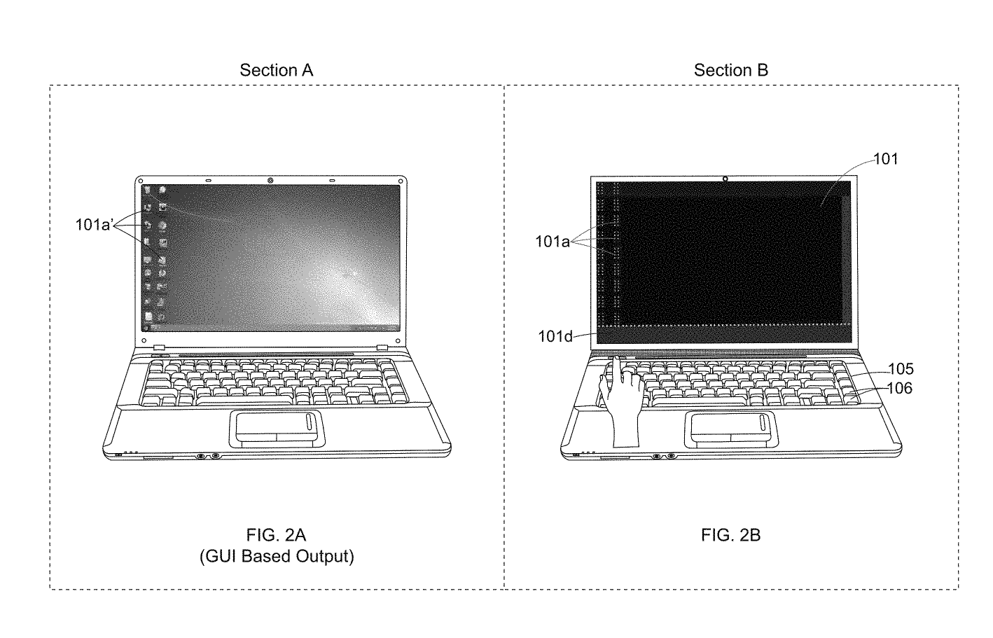

The Figures shows drawings in two sections, SECTION-A and SECTION-B. It is to be noted that the drawings illustrating the present invention is shown in SECTION-B. SECTION-A, FIGS. 2A-19A and 21A, illustrates conventional Laptop with Graphical User Interface (GUI), shown only for side-by-side comparison with the present invention that is shown n SECTION-B FIGS. 1, 2B-19B, and 21B for ease in understanding the invention and for showing similarities between operating of conventional. GUT based computers/user interfaces (shown in SECTION-A) and the user interface for blind of the present invention (shown in SECTION-B).

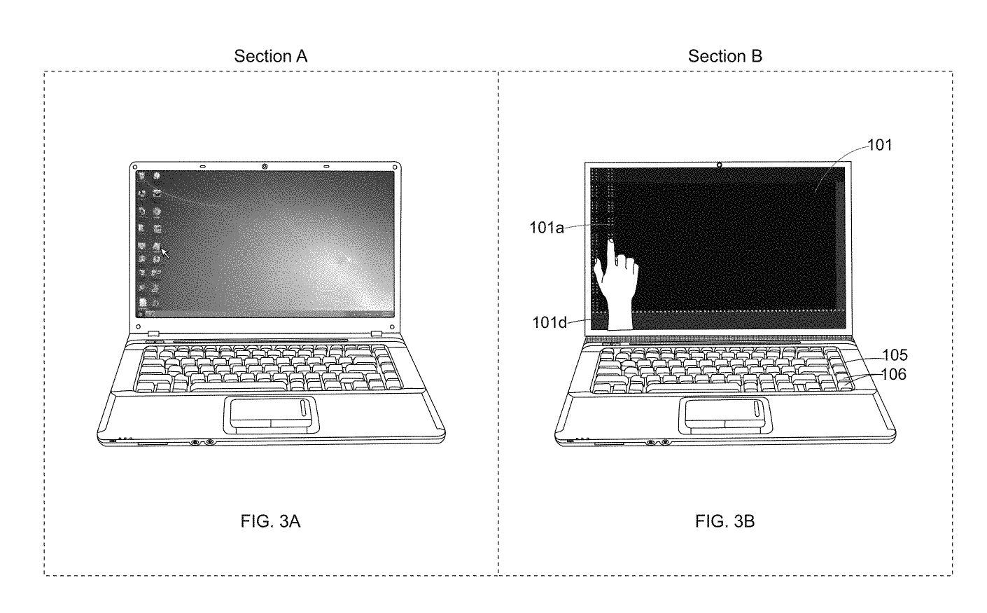

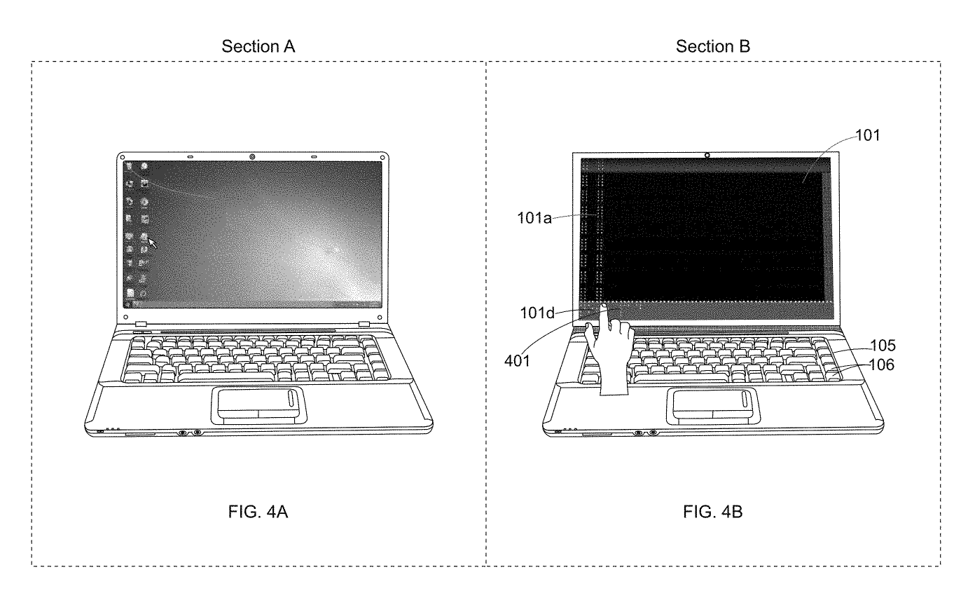

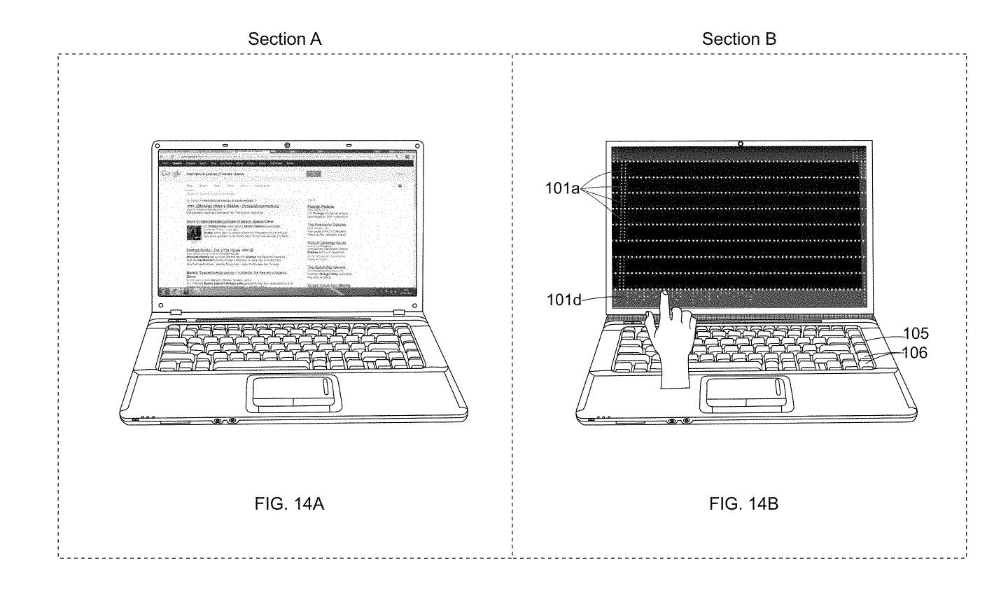

FIG. 1 illustrates a laptop computer 100 in an open position with user interface 101 according to an embodiment of the present invention. The user interface 101 comprises a single interface 101 for generating tactile output for enabling a blind user to read data, and for receiving tactile input from user. A webcam 108 may be provided in the laptop computer 100. The interface 101 comprises plurality of elements 103 representing a dot of Braille character arranged in cluster of two columns by four rows denoting a ‘8-dot Braille cell’ 104. The 8-dot Braille cells are arranged in rows separated by horizontal line 102. The horizontal line 102 is formed of same elements but pronounced than the elements 103 forming the 8-dot Braille cell 104. The user interface 101 comprises four types of regions. FIGS. 2B, 3B, 4B, 10B, 11B, 14B, 15B, 16B, 17B and 18B illustrate a first type of region adapted as first tactile symbol 101a representing computer icon or referring to compressed data. A tactile input is provided on the first tactile symbol 101a to read the first tactile symbol as shown in FIG. 3B. In response to the tactile input on the first tactile symbol 101a, details or explanation relating to the first tactile symbol 101a is generated in a separate fourth region 101d in tactile Braille characters 401 as shown in FIG. 4B. As shown in FIG. 4B, the user can read the meaning of the first tactile symbol 101a representing a particular computer icon, here a notepad shown in an example. A conventional laptop with a GUI displaying computer icons is shown in SECTION-A, FIG. 4A, to compare similarities of information presentation or layout of computer icons in a GUI with first tactile symbol 101a layout of the user interface 101 of the present invention as shown in SECTION-B, FIG. 4B. The first tactile symbol 101a may also represent or refer to compressed data as shown in FIG. 14B, where results of internet search during operation/use of the laptop computer by blind user is depicted in a layout of first tactile symbol 101a easily comprehensible by blind user on providing input on the first tactile symbol 101a. A conventional laptop with a GUI displaying results of internet search is shown in SECTION-A, FIG. 14A, for ease of understanding and comparing similarities of information presentation during internet search or layout of search results with first tactile symbol 101a layout of the user interface 101 of the present invention. This is a smart way of information presentation for blind user in the user interface 101 of the laptop computer 100 making the user interface very easy to use and self-exploratory.

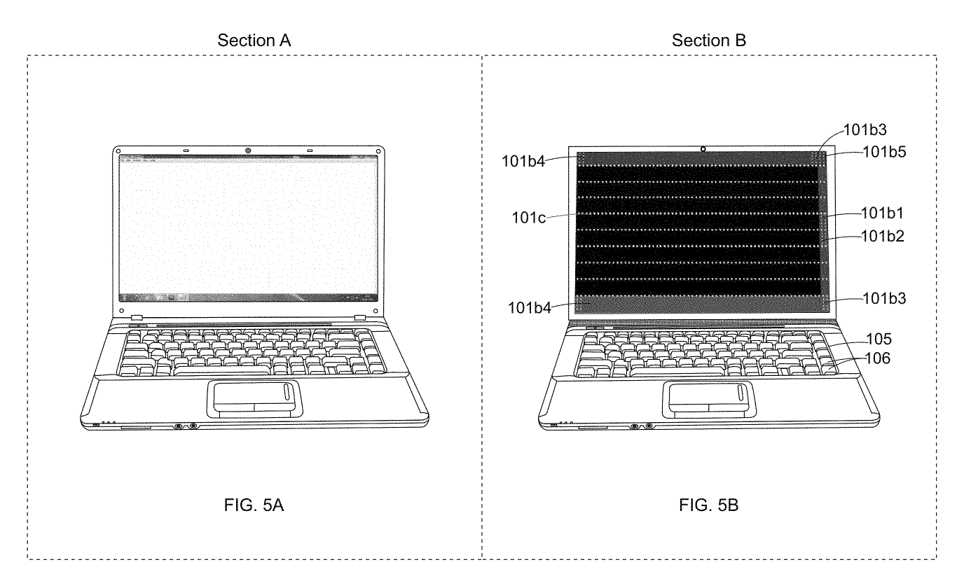

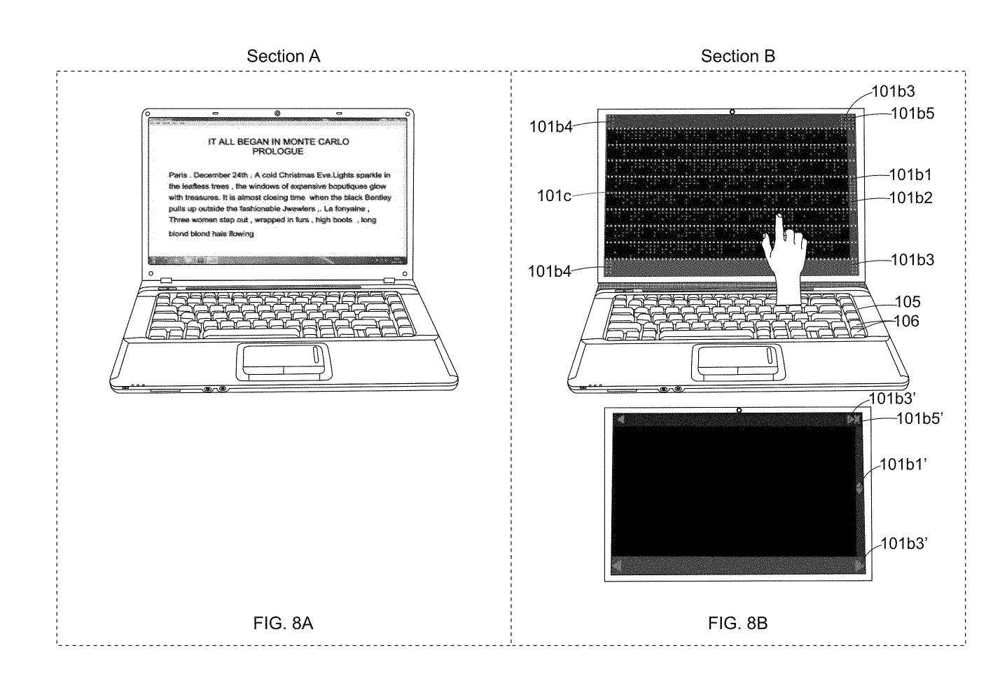

FIGS. 5B-9B illustrate a second type of region adapted as second tactile symbols (101b1, 101b2, 101b3,101b4,101b5) provided for selecting instruction directly that the second tactile symbols represents. As shown in FIG. 8B, the second tactile symbol 101b1 represent instruction for upwards vertical scroll 101b1′, the second tactile symbol 101b2 represent instruction for downwards vertical scroll 101b2′, the second tactile symbol 101b3 represent instruction for right-side horizontal scroll 101b3′, the second tactile symbol 101b4 represent instruction for left-side horizontal scroll 101b4′, the second tactile symbol 101b5 represent instruction for closing 101b5′ an application or file.

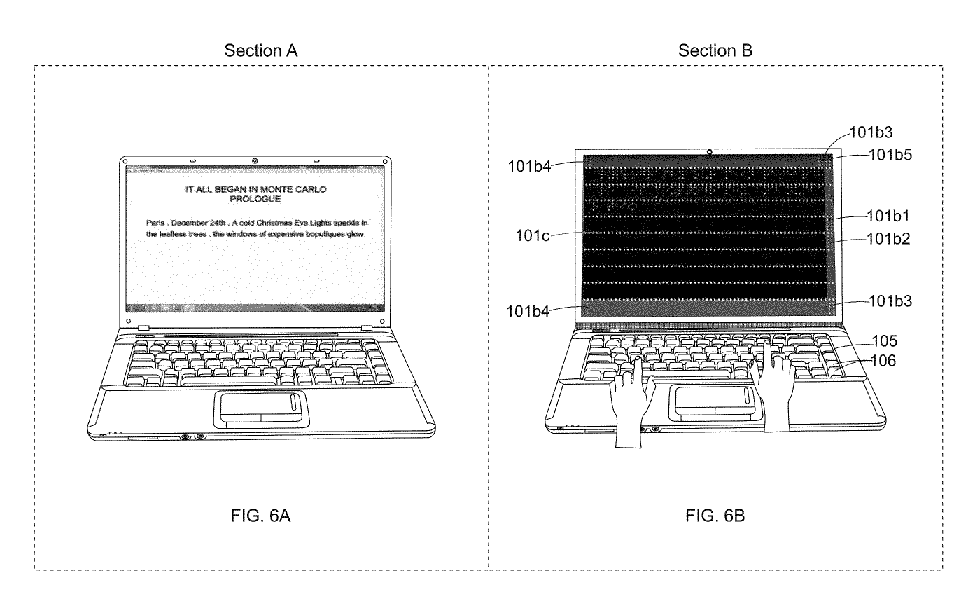

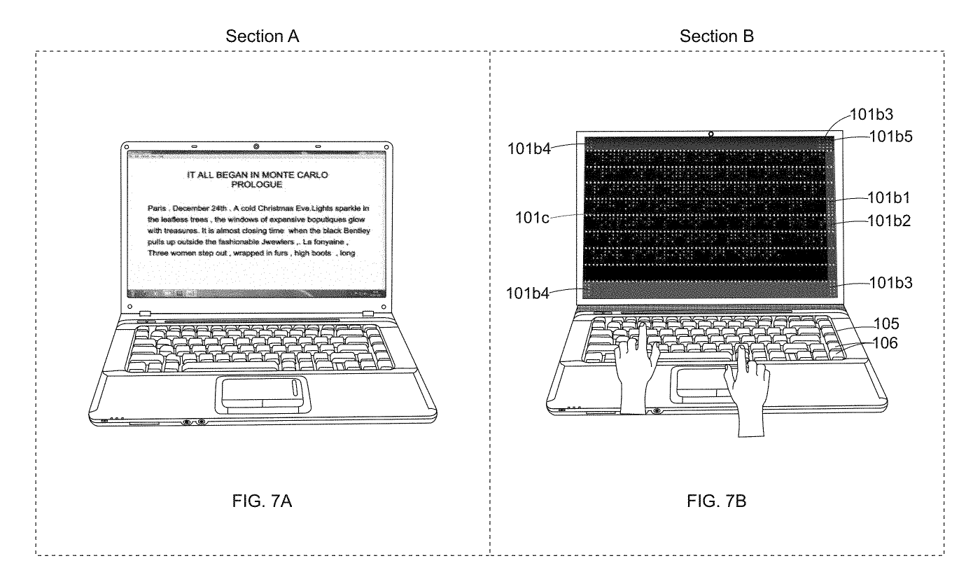

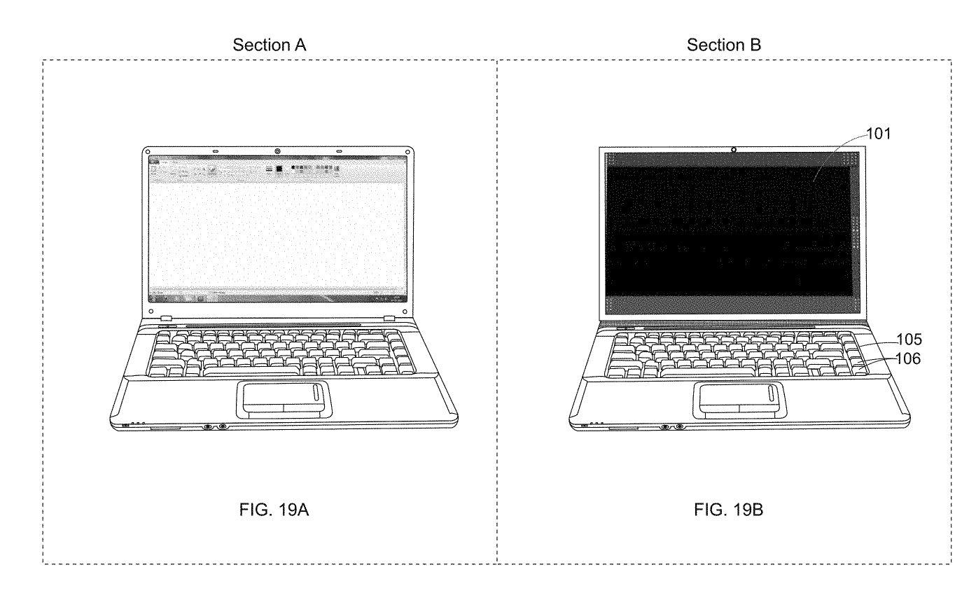

FIGS. 5B-9B, 12B, 13B, 16B illustrate a third type of region adapted to output text data in tactile Braille characters form and/or free form tactile output for representing drawings or arbitrary tactile shapes or lines other than Braille Characters. The third region is also adapted to receive tactile input directly on the interface as shown in FIG. 19 using a stylus 107 or receive input via one or more input device such as keyboard 105 with raised letters as shown in FIGS. 6B and 7B. The raised letters may be a alphabetical letters raised for perception by blind user in one embodiment or may a raised Braille characters in another embodiment. The arrangement of keys 106 is preferably in QWERTY keyboard style for quick typing.

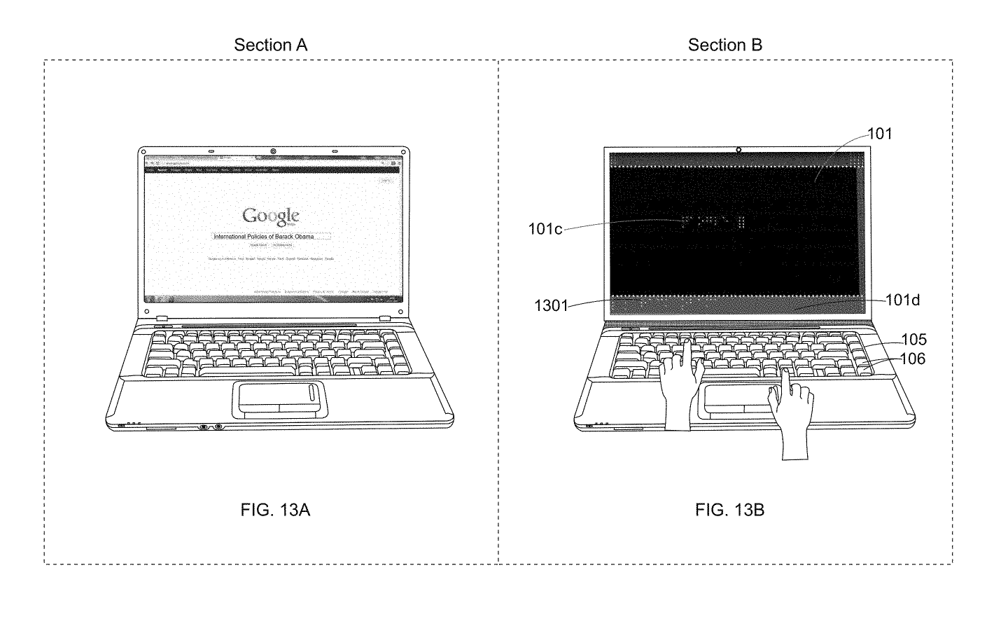

FIGS. 2B-19B, 20 and 21B illustrate the fourth type of region adapted to output text data in tactile Braille characters either as a tactile response to input on the first tactile symbol for providing details or explanation as discussed above and shown in FIG. 4B or as a tactile response to input received from one or more input device as shown in FIG. 13B, where input is keyed in for writing data in text as Braille characters 1301. The tactile input using finger or the stylus 107 directly on the interface 101 generates a tactile feedback on the same interface 101.

The four regions of the interface 101 housing plurality of ‘8-dot Braille cell’ 104 and horizontal line 102 is formed of a tactile layer that dynamically extents and retracts elements 103 that represents a dot of Braille character using underlying mechanical sub-layer. An intermediating software layer may be provided that converts touch input signals received through tactile input on the interface 101 to input signals acceptable by operating system or computer. The intermediating software layer is also responsible for converting input signals received from operating system or computer to output signals for controlling tactile output display. Input signals are received through computer when user provides input through other input mode such as a keyboard with raised letters. The raised letters may be Braille character consists of a three row by two column “cell” or an alphabetical letter of a language such as English. The extending and retracting of elements 103 may be achieved using conventional actuators such as piezoelectric materials, shape memory alloys or solenoids.

FIG. 2B-9B illustrates using or operating the laptop computer 100 and/or the user interface 101 of FIG. 1 for writing notes and verifying written notes in one example. In FIG. 2B, the interface 101 is shown in power-on mode of the laptop computer 100 displaying the first tactile symbols 101a. The first tactile symbols 101a represents computer icons 101a′ as of a GUI in a conventional computer as shown in FIG. 2A for comparison and ease of understanding the invention. A user on providing tactile input on one first tactile symbols 101a as shown in FIG. 3B, a tactile feedback in the form of text with extended Braille dots displaying Braille characters 401 is outputted in the separate fourth region 101d as shown in FIG. 4B. The user reads the Braille characters, say notepad, comprehending the meaning of the first tactile symbols 101a. The first tactile symbols 101a are uniform symbols. The uniform symbol, here represented by all 8 extended Braille dots in a 8-dot Braille cell, helps the blind user to easily indentify that the first tactile symbols 101a contain further details, and moves hand to the fourth region 101d for reading details or explanation 401 for the corresponding first tactile symbol 101a.

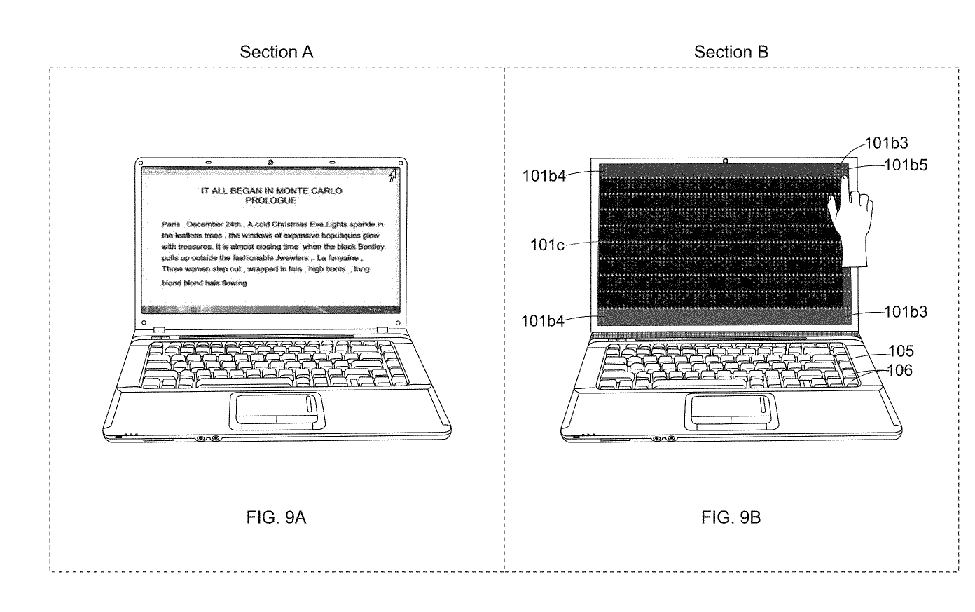

A further input opens the text processor (text processing application) as shown in FIG. 5B similar to opening a notepad in a conventional GUI of convention computer as shown in FIG. 5A. The blind user may provide input using the keyboard 105 comprising embossed or raised letters, and corresponding output is generated/displayed in the interface 101 in the third region 101c as shown in FIG. 6B. FIG. 7B shows further input and corresponding output in the third region 101c of the interface 101. Corresponding output of FIG. 6B and FIG. 7B is shown in FIG. 6A and FIG. 7A respectively in notepad application of known operating system such as WINDOWS® in conventional computer for ease of understanding. The user may verify if the text inputted is correct in the interface by reading the tactile output of Braille characters as shown in FIG. 8B. The user may use the second tactile symbols (101b1,101b2,101b3,101b4,101b5) for navigation and scrolling. After completion of taking notes, the user can exit the text processor providing tactile input using the second tactile symbol. 101b5 as shown in FIG. 9B.

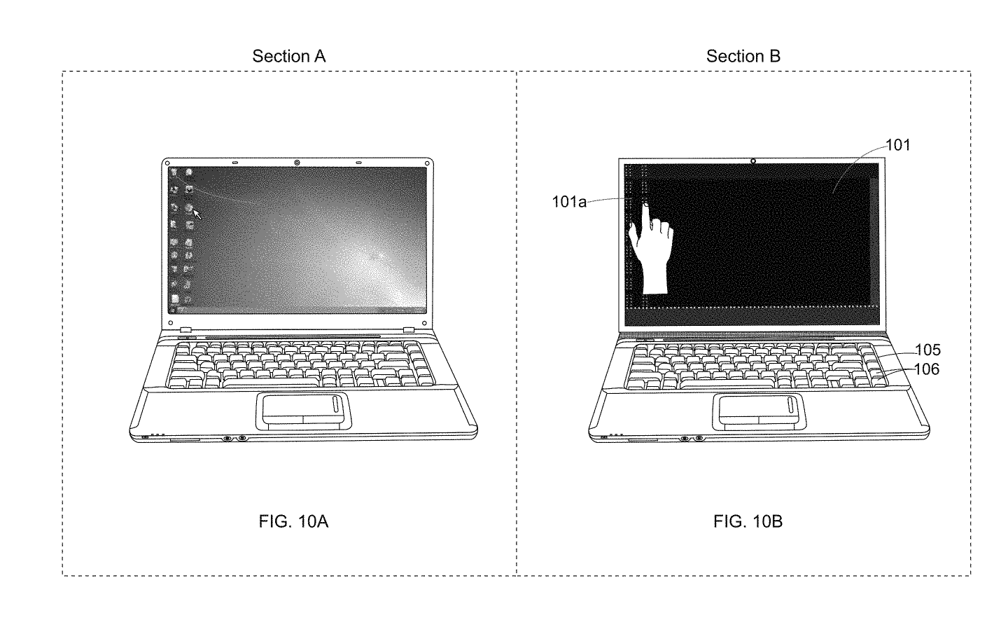

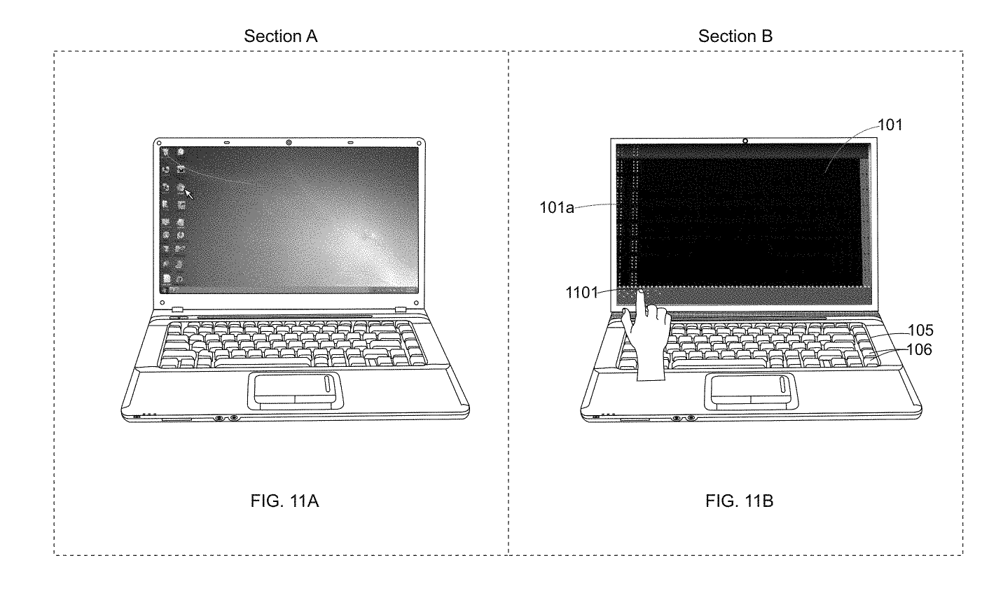

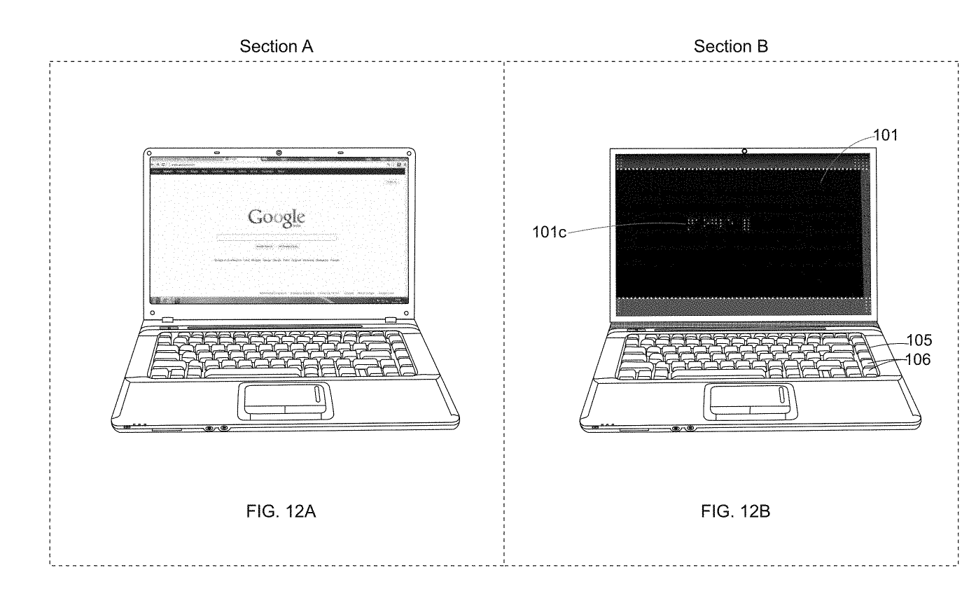

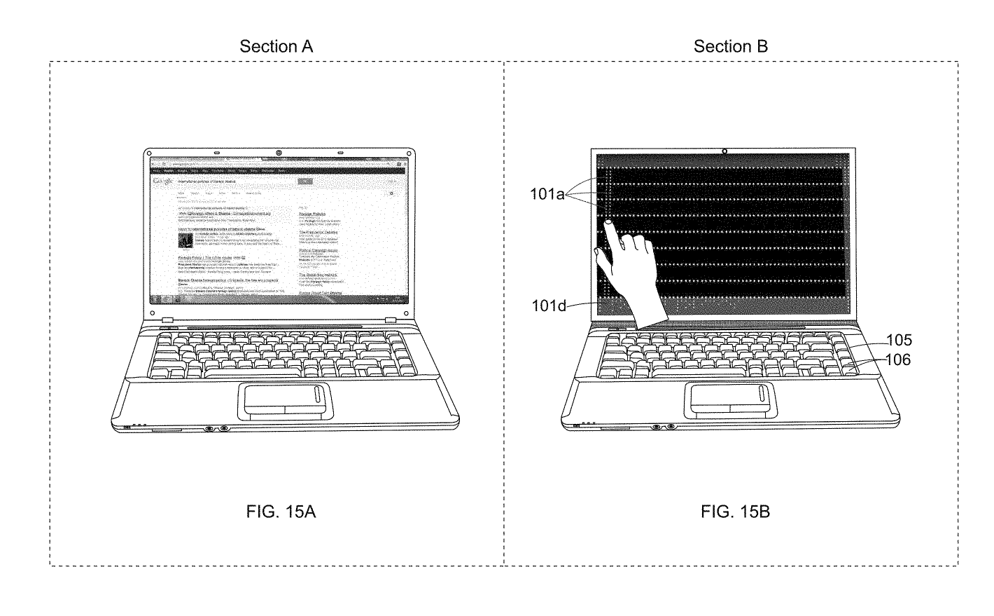

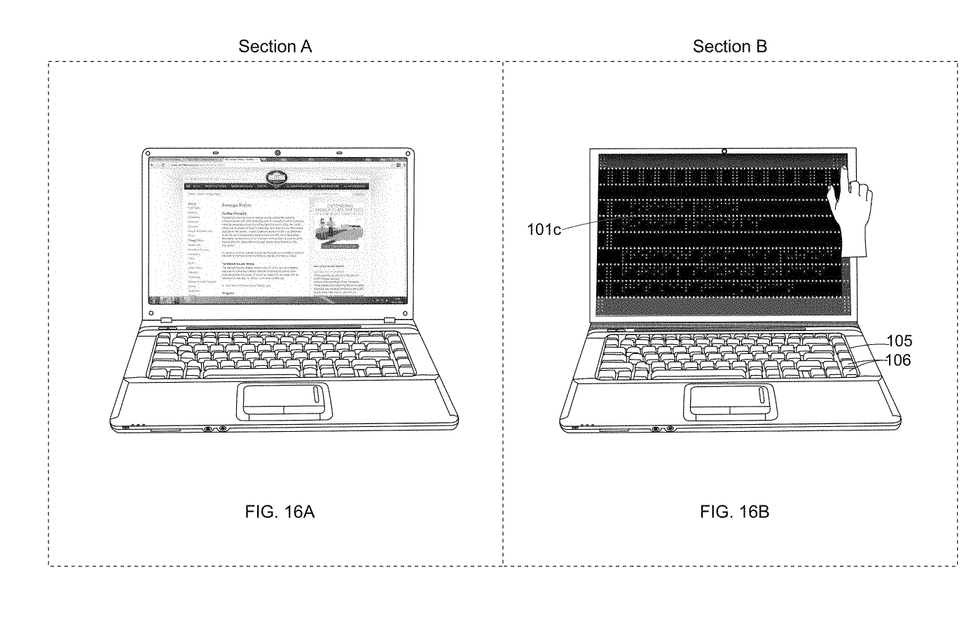

FIG. 10B-16B illustrates using or operating the laptop computer and/or the user interface of FIG. 1 for navigating the Internet independently in one example. The user now provides tactile input on another first tactile symbols 101a as shown in FIG. 10B, a tactile feedback in the form of text with extended Braille dots representing Braille characters 1101 is outputted in the separate fourth region 101d as shown in FIG. 11B. The user reads the Braille characters, here Google®, comprehending the meaning of the first tactile symbols 101a, to perform internet search. A further input opens the search website, and converts the webpage layout to tactile form perceivable by blind user as shown in FIG. 12B similar to opening Google search webpage in a conventional GUI of convention computer as shown in FIG. 12A. The blind user may provide input search query as Braille characters 1301 using the keyboard 105 in the fourth region 101d, and corresponding output is generated/displayed in the interface 101 in the fourth region 101d as shown in FIG. 13B. The results of Internet search is depicted in a layout of first tactile symbol 101a, each tactile symbol 101a representing one heading as shown in FIG. 14B. Corresponding output of FIG. 14B is shown in FIG. 14A in a webpage GUI in conventional computer for ease of understanding. The result query is easily navigable and comprehensible by blind user on providing input on the first tactile symbol 101a as shown in FIG. 15A, where after reading details, tactile input is provided to open webpage. FIG. 16B shows layout of webpage converted to tactile output to enable blind user to read the webpage easily. The menu is converted to second tactile symbols. The content can be read in third region 101c. Corresponding output of FIG. 16B is shown in FIG. 16A in a webpage GUI in conventional computer for ease of understanding.

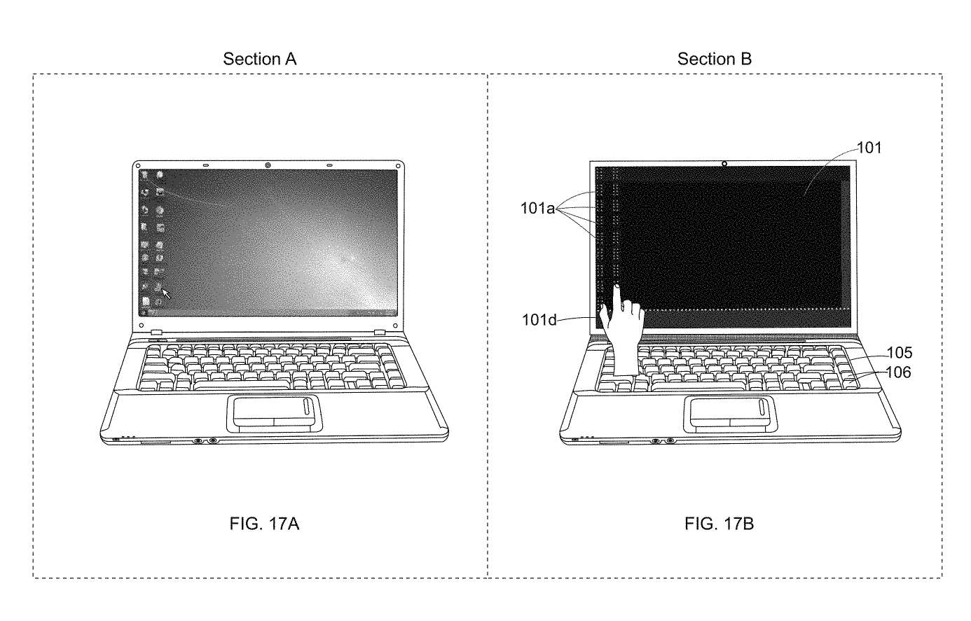

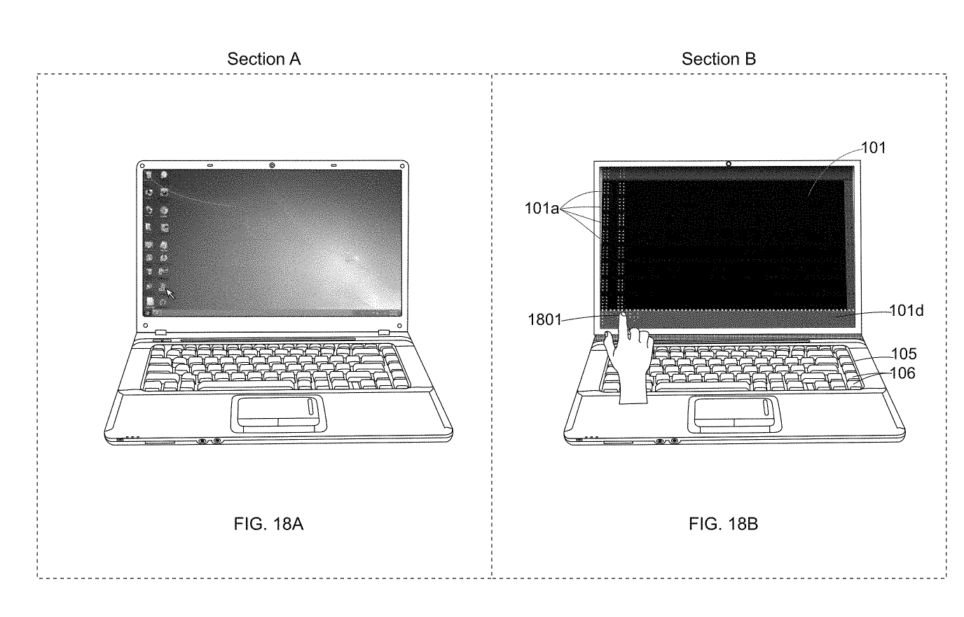

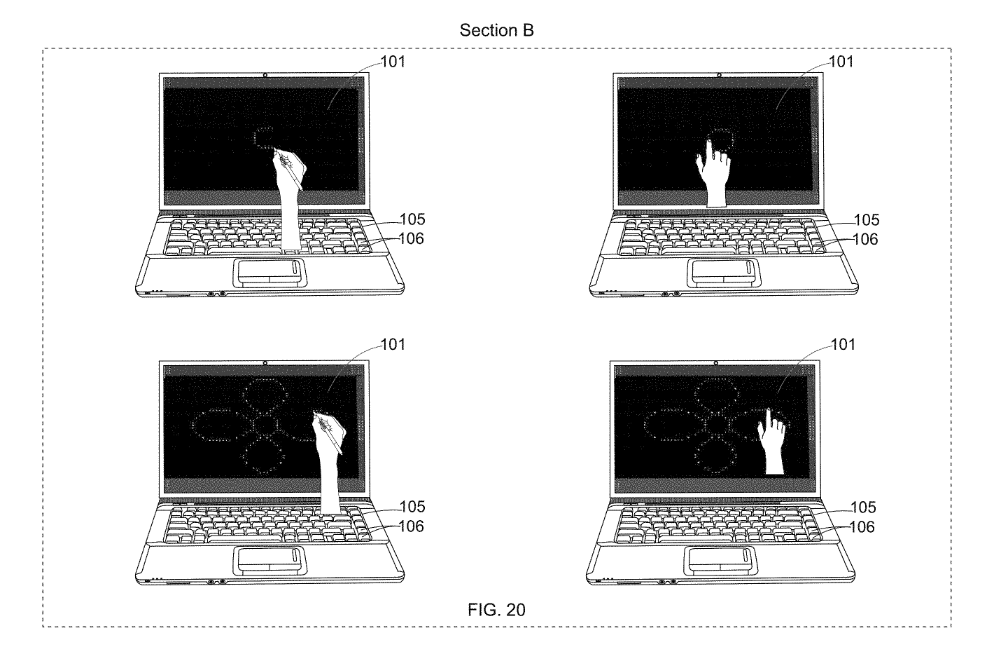

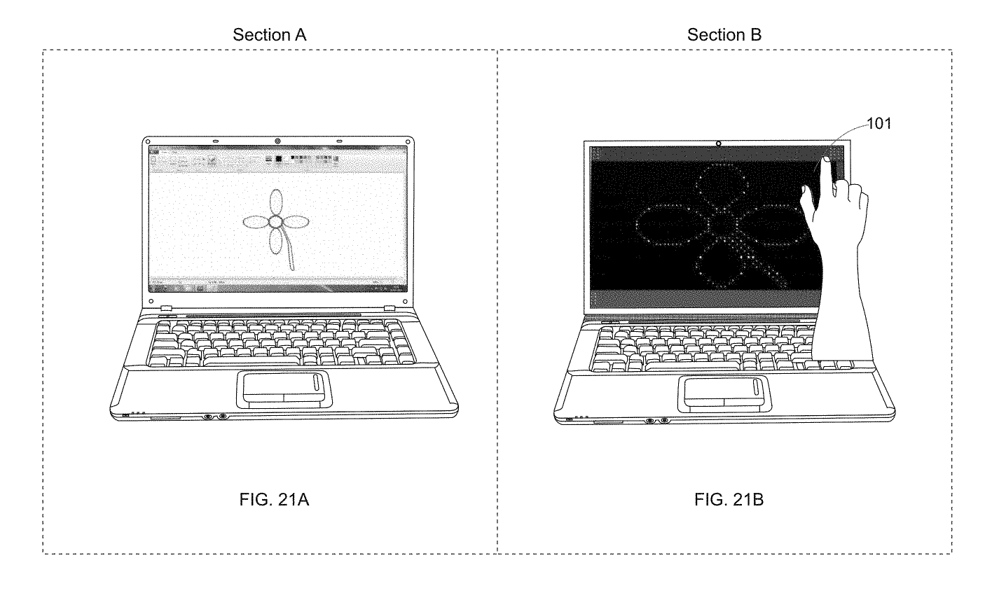

FIGS. 17B, 18B, 19B, 20 and 21B illustrates using or operating the laptop computer and/or the user interface of FIG. 1 for creating drawings in one example. The user is shown provides tactile input on yet another first tactile symbols 101a as shown in FIG. 17B. A tactile feedback in the form of text with extended Braille dots representing Braille characters 1801 is outputted in the separate fourth region 101d as shown in FIG. 18B. A further input opens draw feature or application in tactile form as shown in FIG. 19B similar to opening a paint application in a conventional GUI of convention computer as shown in FIG. 19A. FIG. 20 shows user carrying out drawings by tactile input directly on the interface 101 in the third region 101c as shown in FIG. 20 using the stylus 107. The stylus when touches the interface 101 in the draw feature, the elements representing Braille dots gets extended simultaneously as shown in different views of FIG. 20. The final output is shown in FIG. 21B. A corresponding output of FIG. 21B is shown in FIG. 21A in Paint application of known operating system in conventional computer for ease of understanding.

The tactile display screen of computer for blind is refreshable braille display or braille terminal which is an electro-mechanical device for displaying braille characters, usually by means of round-tipped pins raised through holes in a flat surface. The mechanism which raises the dots uses the piezo effect of some crystals, whereby they expand when a voltage is applied to them. Such a crystal is connected to a lever, which in turn raises the dot. There has to be a crystal for each dot of the display. Generally, prototypes and commercial products are electro-mechanical devices that raise dots through holes in a flat surface. Over the years, researchers developed and tested various actuators and mechanisms, such as electromagnetic, piezoelectric, thermal, pneumatic, and shape memory alloys.

In recent years, many electroactive polymer (EAP) materials have emerged with the potential to enable active, full-page displays. The concept is based on using a field-activated type EAP actuator configured in an array form.

The Application Programming Interface software which controls the display, gathers the content of the screen from the operating system, software application or webpage and converts it into Braille characters special symbol of operating system based symbols and convert headings name into a unique type of Braille symbol and sends signals to refreshable tactile display to move pin.

While the invention is susceptible to various modifications and alternative forms, specific embodiments thereof have been shown by way of example in the drawings and are herein described in detail.

We claim:

1. A computing device for visually impaired with a tactile refreshable Braille display, the display is adapted to show a computer application, the computer application is characterized by presence of one of command/control/tool button symbols and names and/or a reading material having at least one of headings names, hyperlink name, or compressed data name and detailed text or graphical GUI, the display is adapted to show the computer application by a combination of one or more of the following:
a unique Braille symbol at different placing on tactile surface represents different command/control button symbols and names, headings names, hyperlink name or compressed data name, wherein meaning of the unique Braille symbol depends according to its placing on the tactile display.
standard Braille character/s representing the detailed text, and
standard Braille character/s at a first predefined region in the tactile display to show meaning of the unique Braille symbol according to placing on tactile surface.

2. The computing device adapted to claim 1 comprising one or more input device from a selection of a tactile keyboard, a touch sensitive tactile display and a voice recognition based input device.

3. The computing device according to any of the claim 1 or 2, wherein the tactile display is adapted to show operating system related command buttons as Operating System based Braille symbol which are adapted to be executed by a first type of user input and to be operated to show meaning of the buttons in the first predefined region on receiving second type of input on the command buttons.

4. The computing device according to any of the claims 1 to 3, wherein the tactile is adapted to display a fill-in box as a unique Braille symbol, and on application of user input over the input box, the display is adapted to open the fill-in box in a second predefined region.

5. The computing device according to any of the claims 1 to 4 comprising a piece of code stored in a memory device which on execution over a processor is adapted to perform the following steps of:
converting data fetched to be displayed on the display device, such that the display device is adapted to display the data according to any of the claims 1 to 4.

6. The computing device according to any of the claims 1 to 5, wherein the display is made of refreshable tactile surface where Braille pixels appear on the surface through the movement of pins, where movement is generated through the electricity based actuators.

7. The computing device according to any of the claims 1 to 6 comprising a Braille typing interface to type onto the display in Braille.

8. The computing device according to any of the claims 1 to 6 comprising a drawing interface to physically interact with the tactile surface to draw onto the tactile surface of the display.

9. The computing device according to any of the claims 1 to 6 comprising a voice output utility which is adapted to convert the desired output shown on display into audio.
